(19) United States
(12) Patent Application Publication
(10) Pub. No.: US 2019/0337446 A1
(43) Pub. Date: Nov. 7, 2019

(54) VEHICLE LIGHTING ASSEMBLY

(71) Applicant: Ford Global Technologies, LLC, Dearborn, MI (US)

(72) Inventors: Stuart C. Salter, White Lake, MI (US); Paul Kenneth Dellock, Northville, MI (US); David Brian Glickman, Southfield, MI (US); James J. Surman, Clinton Township, MI (US)

(73) Assignee: Ford Global Technologies, LLC

(21) Appl. No.: 15/972,538

(22) Filed: May 7, 2018

(51) Int. Cl. B60Q 1/26; B60Q 1/00; B60Q 1/28; F21S 41/32; F21S 41/176; F21S 41/50; F21S 45/10

(52) U.S. Cl. CPC B60Q 1/2661; B60Q 1/0017; B60Q 1/28; B60R 13/005; F21S 41/176; F21S 41/50; F21S 45/10; F21S 41/32

(57) ABSTRACT

A vehicle lighting assembly is provided herein. The vehicle lighting assembly includes a substrate configured to direct excitation light therethrough. A reflector is disposed along a portion of the substrate. The reflector has an offset orientation. A luminescent structure is disposed on an opposing side of the reflector from the substrate.

### FIELD OF THE INVENTION

The present disclosure generally relates to vehicle lighting assemblies, and more particularly, to vehicle lighting assemblies that may be disposed within a vehicle grille.

### BACKGROUND OF THE INVENTION

Exterior vehicle lighting applications continue to grow in popularity. Accordingly, a lighting assembly that may be integrated into a vehicle grille is provided herein that is operable to provide functional lighting as well as impart a stylistic element to a vehicle.

### SUMMARY OF THE INVENTION

According to some aspects of the present disclosure, a vehicle lighting assembly is provided herein. The vehicle lighting assembly includes a substrate configured to direct excitation light therethrough. A reflector is disposed along a portion of the substrate, the reflector having an offset orientation. A luminescent structure is disposed on an opposing side of the reflector from the substrate.

According to some aspects of the present disclosure, a vehicle lighting assembly is provided herein. The vehicle lighting assembly includes a substrate configured to direct excitation light therethrough. A reflector is disposed along a portion of the substrate, the substrate extending upwardly of the substrate. A luminescent structure is disposed on an opposing side of the reflector from the substrate. A panel is disposed on an opposing side of the substrate from the reflector.

According to some aspects of the present disclosure, a vehicle lighting assembly is provided herein. The vehicle lighting assembly includes a light source disposed between a substrate and a panel. A decorative layer is disposed on an opposing side of the substrate from the light source. A luminescent structure disposed on an opposing side of the decorative layer from the substrate. An indicia is disposed on the luminescent structure.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A is a side view of a luminescent structure rendered as a coating, according to some examples;

FIG. 1B is a top view of a luminescent structure rendered as a discrete particle, according to some examples;

FIG. 1C is a side view of a plurality of luminescent structures rendered as discrete particles and incorporated into a separate structure, according to some examples;

FIG. 2 is a front perspective view of a vehicle and a grille, according to some examples;

FIG. 3 is a cross-sectional view of a lighting assembly within the grille taken along line III-III of FIG. 2;

FIG. 4 is a front perspective view of the vehicle and the grille, according to some examples;

FIG. 5 is a cross-sectional view of the lighting assembly within the grille taken along line V-V of FIG. 4; and

FIG. 6 is a block diagram of the illuminated grille and the vehicle, according to some examples.

### DETAILED DESCRIPTION OF THE PREFERRED EXAMPLES

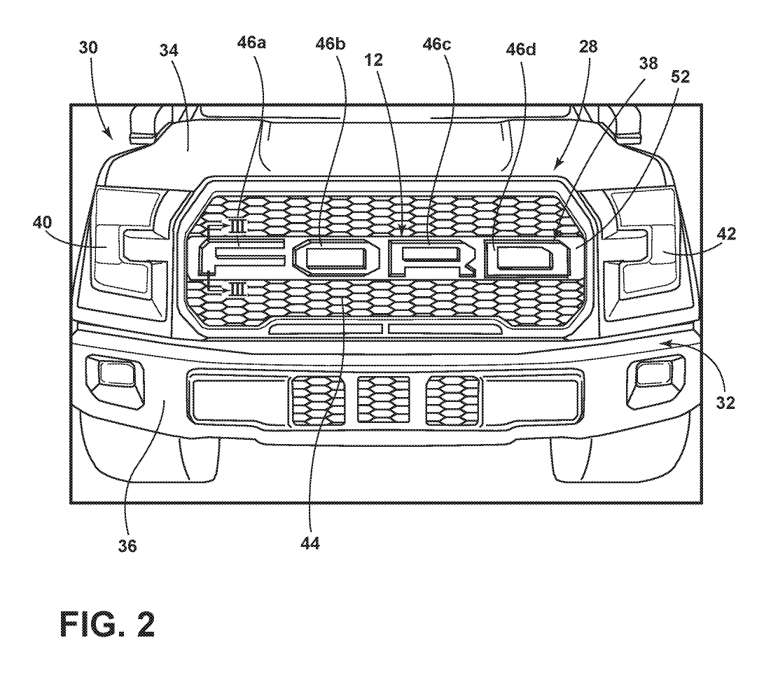

For purposes of description herein, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a grille that may be illuminated for a wide range of purposes. In some examples, the grille may be illuminated to provide aesthetic and/or functional lighting to an area proximate the vehicle. The grille may include a substrate configured to direct excitation light therethrough. A reflector is disposed along a portion of the substrate. The reflector may have an offset orientation to direct light in a desired direction. A luminescent structure and/or phosphorescent structure is disposed within the lighting assembly and configured to luminesce in response to predefined events. The luminescent structure may be configured to convert excitation light and re-emit the light at a different wavelength generally found in the visible spectrum.

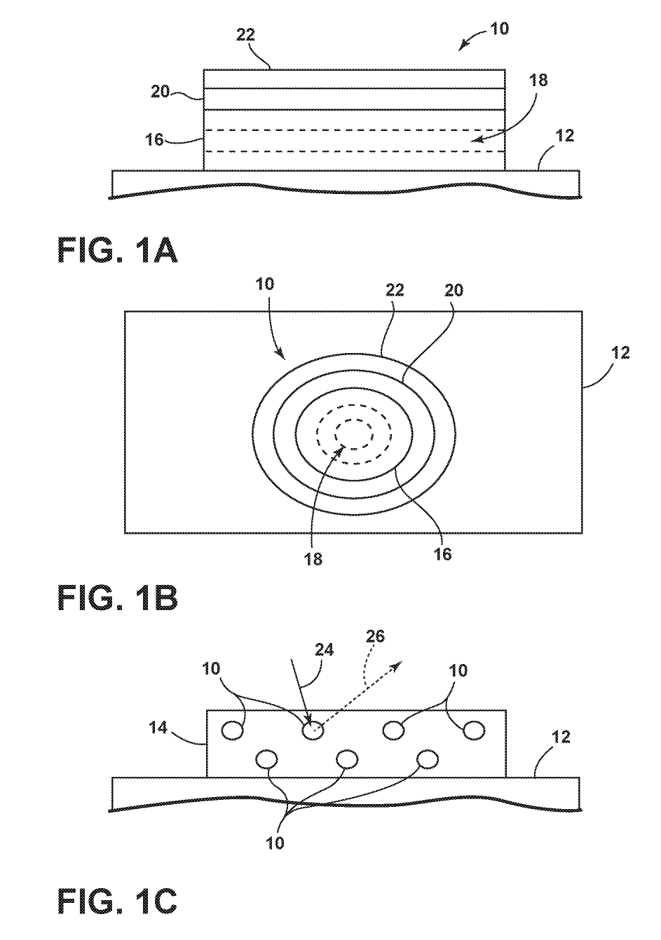

Referring to FIGS. 1A-1C, various exemplary examples of luminescent structures 10 are shown, each capable of being coupled to a substrate 12, which may correspond to a vehicle fixture or vehicle-related piece of equipment. In FIG. 1A, the luminescent structure 10 is generally shown rendered as a coating (e.g., a film) that may be applied to a surface of the substrate 12. In FIG. 1B, the luminescent structure 10 is generally shown as a discrete particle capable of being integrated with a substrate 12. In FIG. 1C, the luminescent structure 10 is generally shown as a plurality of discrete particles that may be incorporated into a support medium 14 (e.g., a film) that may then be applied (as shown) or integrated with the substrate 12.

At the most basic level, a given luminescent structure 10 includes an energy conversion layer 16 that may include one or more sublayers, which are exemplarily shown in broken lines in FIGS. 1A and 1B. Each sublayer of the energy conversion layer 16 may include one or more luminescent materials 18 having energy converting elements with phosphorescent or fluorescent properties. Each luminescent material 18 may become excited upon receiving an excitation light 24 of a specific wavelength, thereby causing the light to undergo a conversion process. Under the principle of down conversion, the excitation light 24 is converted into a longer-wavelength, converted light 26 that is outputted from the luminescent structure 10. Conversely, under the principle of up conversion, the excitation light 24 is converted into a shorter wavelength light that is outputted from the luminescent structure 10. When multiple distinct wavelengths of light are outputted from the luminescent structure 10 at the same time, the wavelengths of light may mix together and be expressed as a multicolor light.

The energy conversion layer 16 may be prepared by dispersing the luminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For example, the energy conversion layer 16 may be rendered by dispersing the luminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In various examples, the converted light 26 that has been down converted or up converted may be used to excite other luminescent material(s) 18 found in the energy conversion layer 16. The process of using the converted light 26 outputted from one luminescent material 18 to excite another, and so on, is generally known as an energy cascade and may serve as an alternative for achieving various color expressions. With respect to either conversion principle, the difference in wavelength between the excitation light 24 and the converted light 26 is known as the Stokes shift and serves as the principal driving mechanism for an energy conversion process corresponding to a change in wavelength of light. In the various examples discussed herein, each of the luminescent structures 10 may operate under either conversion principle.

Referring back to FIGS. 1A and 1B, the luminescent structure 10 may optionally include at least one stability layer 20 to protect the luminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The luminescent structure 10 may also optionally include a protective layer 22 optically coupled and adhered to the stability layer 20 or other layer (e.g., the conversion layer 16 in the absence of the stability layer 20) to protect the luminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

According to various examples, the luminescent material 18 may include organic or inorganic fluorescent dyes including rylenes, xanthenes, porphyrins, and phthalocyanines. Additionally, or alternatively, the luminescent material 18 may include phosphors from the group of Ce-doped garnets such as YAG:Ce and may be a short-persistence luminescent material 18. For example, an emission by Ce³⁺ is based on an electronic energy transition from 4 D¹ to 4 f¹ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (10 to 100 nanoseconds). The decay time may be defined as the time between the end of excitation from the excitation light 24 and the moment when the light intensity of the converted light 26 emitted from the luminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

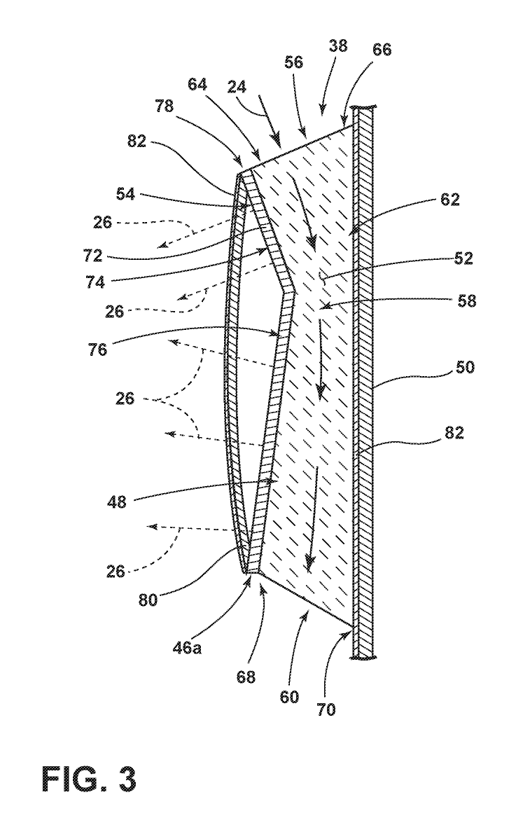

According to various examples, a Ce³⁺ garnet may be utilized, which has a peak excitation spectrum that may reside in a shorter wavelength range than that of conventional YAG:Ce-type phosphors. Accordingly, Ce³⁺ has short-persistence characteristics such that its decay time may be 100 milliseconds or less. Therefore, in various examples, the rare earth aluminum garnet type Ce phosphor may serve as the luminescent material 18 with ultra-short-persistence characteristics, which can emit the converted light 26 by absorbing purple to blue excitation light 24 emanated from light sources 88 (FIG. 3). According to various examples, a ZnS:Ag phosphor may be used to create a blue-converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short-persistence luminescent material 18 known in the art may be utilized without departing from the teachings provided herein.

Additionally, or alternatively, the luminescent material 18, according to various examples, disposed within the luminescent structure 10 may include a long-persistence luminescent material 18 that emits the converted light 26, once charged by the excitation light 24. The excitation light 24 may be emitted from any excitation source (e.g., any natural light source, such as the sun, and/or any artificial light sources 88). The long-persistence luminescent material 18 may be defined as having a long decay time due to its ability to store the excitation light 24 and release the converted light 26 gradually, for a period of several minutes or hours, once the excitation light 24 is no longer present.

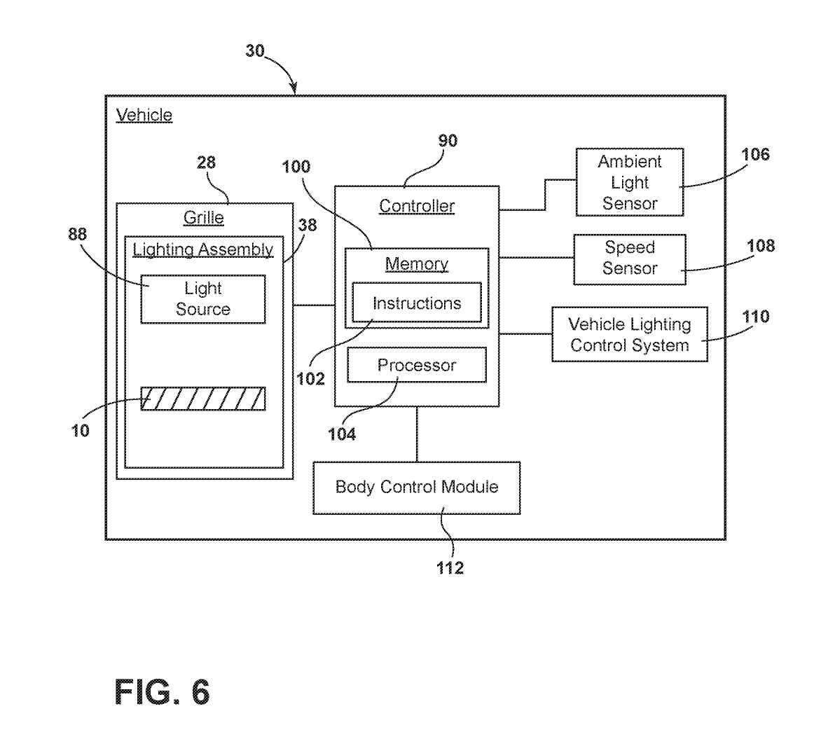

The long-persistence luminescent material 18, according to various examples, may be operable to emit light at or above an intensity of 0.32 mcd/m² after a period of 10 minutes. Additionally, the long-persistence luminescent material 18 may be operable to emit light above or at an intensity of 0.32 mcd/m² after a period of 30 minutes and, in various examples, for a period substantially longer than 60 minutes (e.g., the period may extend 24 hours or longer, and in some instances, the period may extend 48 hours). Accordingly, the long-persistence luminescent material 18 may continually illuminate in response to excitation from any one or more light sources 88 that emit the excitation light 24, including, but not limited to, natural light sources (e.g., the sun) and/or any artificial light sources 88. The periodic absorption of the excitation light 24 from any excitation source may provide for a substantially sustained charge of the long-persistence luminescent material 18 to provide for consistent passive illumination. In various examples, a light sensor 106 (FIG. 6) may monitor the illumination intensity of the luminescent structure 10 and actuate an excitation source when the illumination intensity falls below 0.32 mcd/m², or any other predefined intensity level.

The long-persistence luminescent material 18 may correspond to alkaline earth aluminates and silicates, for example, doped di-silicates, or any other compound that is capable of emitting light for a period of time once the excitation light 24 is no longer present. The long-persistence luminescent material 18 may be doped with one or more ions, which may correspond to rare earth elements, for example, Eu2+, Tb3+, and/or Dy3. According to one non-limiting exemplary example, the luminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The luminescent structure 10, according to various examples, may be a translucent white color, and in some instances reflective, when unilluminated. Once the luminescent structure 10 receives the excitation light 24 of a particular wavelength, the luminescent structure 10 may emit any color light (e.g., blue or red) therefrom at any desired brightness. According to various examples, a blue emitting phosphorescent material may have the structure Li₂ZnGeO₄ and may be prepared by a high-temperature solid-state reaction method or through any other practicable method and/or process. The afterglow may last for a duration of 2-8 hours and may originate from the excitation light 24 and d-d transitions of Mn2+ ions.

According to an alternate non-limiting example, 100 parts of a commercial solvent-borne polyurethane, such as Mace resin 107-268, having 50% solids polyurethane in toluene/isopropanol, 125 parts of a blue-green long-persistence phosphor, such as Performance Indicator PI-BG20, and 12.5 parts of a dye solution containing 0.1% Lumogen Yellow F083 in dioxolane may be blended to yield a low rare earth mineral luminescent structure 10. It will be understood that the compositions provided herein are non-limiting examples. Thus, any phosphor known in the art may be utilized within the luminescent structure 10 without departing from the teachings provided herein. Moreover, it is contemplated that any long-persistence phosphor known in the art may also be utilized without departing from the teachings provided herein.

Referring to FIG. 2, a grille 28 of a vehicle 30 is generally supported on a front body structure 32 of the vehicle 30. The grille 28 is generally positioned proximately to a hood 34 and a bumper assembly 36. In some instances, the grille 28 may be removably attached to the vehicle 30 such that various grilles 28 may be interchangeably disposed thereon. In some examples, the grille 28 includes a lighting assembly 38 that may be disposed between a pair of headlamps 40, 42. However, the lighting assembly 38 may be disposed in any orientation and on any portion of the vehicle 30 without departing from the scope of the teachings provided herein.

The grille 28 may further include vanes 44 that further impart a style to the grille 28. The grille 28 may be planar or arcuate to impart a linear or non-linear contour to the front body structure 32 of the vehicle 30. The grille 28 may also include indicia 46a-46d, or an emblem, affixed to the front of the grille 28. As will be described herein in greater detail, portions of the grille 28 may have a decorative appearance and may be capable of illuminating to provide functional lighting as well as impart a stylistic element to the vehicle 30.

In some examples, the indicia 46a-46d may form a letter that is visible to vehicle onlookers. In other examples, the indicia 46a-46d may form a symbol, logo, or any other desired shape and may identify the manufacturer of the vehicle 30 or any other desired information. In some instances, the letters may protrude and/or otherwise extend forwardly of a portion of the grille 28 and/or vehicle 30. The indicia 46a-46d may be illuminated and/or backlit based on various conditions and design considerations.

Referring to FIG. 3, the lighting assembly 38, and/or grille 28, may be configured as a multilayer component that includes a substrate 48 that may be integrally formed and/or otherwise coupled with a panel 50. The substrate 48 and/or the panel 50 may be formed from a polymeric material (including thermoplastic and thermosetting polymeric materials), an elastomeric material, a metallic material, combinations thereof, and/or any other material known in the art. The polymeric materials include thermoplastic and thermosetting polymeric materials, e.g., silicones, acrylics, and polycarbonates. In some examples, a precursor material is selected to form the substrate 48 and/or the panel 50 that have a high flow rate and/or a low viscosity during a molding process, such as injection molding. In other examples, the precursor material is selected with higher viscosity levels based on cost or other considerations when a less viscosity-dependent process is employed, such as insert molding. The substrate 48 and/or the panel 50 can take on any of a variety of shapes, depending on the features of the substrate 48 and/or the panel 50 and other design considerations. For example, in some examples, one or more of the surfaces of the substrate 48 and/or the panel 50 are planar (e.g., faceted), non-planar, curved or characterized by other shapes. As understood by those with ordinary skill in the field, the surfaces can be characterized with portions having planar features and portions having non-planar features. Any method can be used for attaching the substrate 48 to the panel 50 including bonding by adhesion, such as by using a double-sided tape, or by mechanical connections, such as brackets.

The substrate 48 may form the indicia 46a that extend forwardly of the panel 50. In some instances, the substrate 48 may include and/or function as a light guide that directs excitation light 24 within a space 52 between an outer portion 54 of the substrate 48 and the panel 50 and/or along the luminescent structure 10. In response to receiving excitation light 24 that is directed through the substrate 48, the converted light 26 may be emitted from the outer portion 54 of the substrate 48.

The substrate 48 may be a substantially transparent or translucent guide suitable for transmitting light (e.g., excitation light 24). The substrate 48 may be formed from a polymeric material (including thermoplastic and thermosetting polymeric materials), an elastomeric material, a metallic material, combinations thereof, and/or any other material known in the art. The substrate 48 may be formed from a rigid material that is comprised of a curable substrate 48 such as a polymerizable compound, a mold in clear (MIC) material, mixtures thereof, and/or any other material known in the art. In other instances, the substrate 48 may include an acrylate or a polymethyl methacrylate (PMMA) material. A polycarbonate material may also be used in an injection molding process to form the rigid substrate 48.

Further, the substrate 48 may be a flexible light guide, wherein a suitable flexible material is used to create the substrate 48. Such flexible materials include urethanes, silicone, thermoplastic polyurethane (TPU), or other like optical grade flexible materials. In such instances, contact may be made to the substrate 48 (i.e., indicia 46a) without causing damage. Whether the substrate 48 is flexible or rigid, the substrate 48, when formed, is substantially optically transparent and/or translucent and capable of transmitting light. The substrate 48 may be referred to as a light guide, a light pipe, a light plate, a light bar or any other light carrying or transmitting substrate 48 made from a clear or substantially translucent material.

With further reference to FIG. 3, the substrate 48 may have an upper portion 56 that is capable of accepting excitation light 24, a middle portion 58, and a lower portion 60. In some examples, excitation light 24 may enter the lower portion 60 of the substrate 48 in conjunction with, or in lieu of the upper portion 56. Similarly, in some instances, the outer portion 54 and/or an inner portion 62 of the substrate 48 may also be capable of accepting excitation light 24. Moreover, the upper portion 56 may have a front portion 64 and a rear portion 66, the rear portion 66 may be disposed vertically above the front portion 64, which may assist in increasing the amount of excitation light 24 that is directed into the substrate 48. Likewise, the lower portion 60 may also have a front portion 68 and a rear portion 70 with the rear portion 70 being disposed vertically lower the front portion 68.

Still referring to FIG. 3, a reflector 72 may be operably coupled and/or integrally formed with the substrate 48. The reflector 72 may be disposed on an opposing side of the substrate 48 from the panel 50. In some examples, the reflector 72 may have a first section 74 that is offset from a second section 76. In some instances, the first section 74 may be angled downwardly while the second section 76 may be angled upwardly. However, it will be appreciated that the first and second sections 74, 76 may be in any orientation without departing from the scope of the present disclosure. In some examples, a top portion 78 of the reflector 72 may terminate at a position below the upper portion 56 of the substrate 48. Likewise, a bottom portion 80 of the reflector 72 may terminate above the lower portion 60 of the substrate 48.

The reflector 72 may be translucent thereby allowing excitation light 24 within the substrate 48 to at least partially pass therethrough. In some examples, the reflector 72 may be formed from a polymer and/or a film that is disposed along the substrate 48. The luminescent structure 10 may be disposed on the reflector 72. In some examples, the luminescent structure 10 may appear in a first color (e.g., white) in a non-luminescent state and emit converted light 26 of a second color (e.g., blue) in a luminescent state. The converted light 26 corresponds to a visible light, which includes the portion of the electromagnetic spectrum that can be detected by the human eye (˜390-700 nanometers in wavelength) and may be expressed in a variety of colors defined by a single wavelength (e.g., red, green, blue) or a mixture of multiple wavelengths (e.g., white). Thus, it should be understood that the luminescent structure 10 may be configured such that excitation light 24 (i.e., a mixture of the excitation light 24 and converted light 26) is capable of being expressed as unicolored or multicolored light. In some instances, the luminescent structure 10 may include a long-persistence luminescent material, as described above, such that the luminescent structure 10 may luminesce for extended durations, such as a period of several minutes or hours, once a night-like lighting condition occurs.

In operation, the luminescent structure 10 receives the excitation light 24 and, in response, luminesces. According to various examples, the luminescent structure 10 discussed herein is substantially Lambertian; that is, the apparent brightness of the luminescent structure 10 is substantially constant regardless of an observer's angle of view. As described herein, the color of the converted light 26 may be dependent on the particular luminescent materials 18 utilized in the luminescent structure 10. Additionally, a conversion capacity of the luminescent structure 10 may be dependent on a concentration of the luminescent material 18 utilized in the luminescent structure 10. By adjusting the range of intensities that may excite the luminescent structure 10, the concentration, types, and proportions of the luminescent materials 18 in the luminescent structure 10 discussed herein may be operable to generate a range of color hues of the excitation light 24 by blending a first wavelength with a second wavelength.

As provided herein, the substrate 48 may define one or more indicia 46a. Depending on the lighting conditions surrounding the vehicle 30 and/or produced by the vehicle 30, such as whether the vehicle 30 is in day-like conditions (i.e., higher light level conditions) and/or whether the vehicle 30 is in night-like conditions (i.e., lower light level conditions), the luminescent structure 10 and/or the reflector 72 may cause the indicia 46a to appear in various colors. For example, in some instances, during day-like conditions, the luminescent structure 10 and/or the reflector 72 may appear in the first color. During night-like conditions, the luminescent structure 10 may emit converted light 26 in the second color. The converted light 26 escapes from the indicia 46a and/or the around the indicia 46a via the, thereby causing the indicia 46a to glow. The offset orientation of the reflector 72 may assist in creating a uniform illumination of the indicia 46a.

In some examples, an overmold material 82 may protect the substrate 48 and/or the luminescent structure 10 from physical and chemical damage arising from environmental exposure. The overmold material 82 may include one or more additives. For example, the overmold material 82 may include one or more materials configured to inhibit the transmission of ultraviolet (UV) light therethrough. Some examples of UV inhibitors that may be integrated into the overmold material 82 may include the following: hindered amines (HALS) or other UV absorbers including oxanilides for polyamides, benzophenones for PVC, and benzotriazoles and hydroxyphenyltriazines for polycarbonate. The UV inhibitors may be configured to block UV light from environmental light sources impinging upon the overmold material 82 from activating the luminescent structure 10.

A reflective material 84 may be disposed on portions of the panel 50 such that excitation light 24 directed through the panel 50 may substantially exit a desired portion of the panel 50. The reflective material 84 may be an additional layer of material that is adhered to the desired portions of the panel 50. The reflective material 84 can be disposed on and/or within the panel 50 through any method known in the art, including, but not limited to, sputter deposition, vacuum deposition (vacuum evaporation coating), electroplating, and/or printing onto the substrate 48. The reflective material 84 may be chosen from a wide range of materials and/or colors, including, but not limited to, silver, chrome, copper, bronze, gold, or any other colored surface (e.g., any color paint). Additionally, an imitator of any metallic material may also be utilized without departing from the teachings provided herein. In various examples, the reflective material 84 may have a textured or grained surface. The grained surface may be produced on various portions of the panel 50 and may provide for the panel 50 to have a varied or common appearance with proximately disposed components of the vehicle 30. The reflective layer may extend upwardly and/or downwardly of the panel 50 and/or the substrate 48. In some examples, the converted light 26 may reflect off the relative layer outwardly of the substrate 48 thereby creating a unique lighting effect, which may appear as a halo.

In some examples, the substrate 48, the luminescent structure 10, and the panel 50 may be integrally formed through a multi-shot molding process. Due to fabrication and assembly steps being performed inside the molds, molded multi-material objects allow a reduction in assembly operations and production cycle times. Furthermore, the product quality can be improved, and the possibility of manufacturing defects and total manufacturing costs can be reduced. In multi-material injection molding, multiple different materials are injected into a multi-stage mold. The sections of the mold that are not to be filled during a molding stage are temporally blocked. After the first injected material sets, then one or more blocked portions of the mold are opened and the next material is injected. This process continues until the required multi-material part is created. According to some examples, a multi-shot molding process is used to create portions of the substrate 48, which may be integrally formed with the panel 50. Further, the reflector 72 may also be integrally formed with the substrate 48 through an additional injection-molding step. Next, the luminescent structure 10 may be disposed on the reflector 72 or later applied to a surface of the reflector 72 and/or the substrate 48.

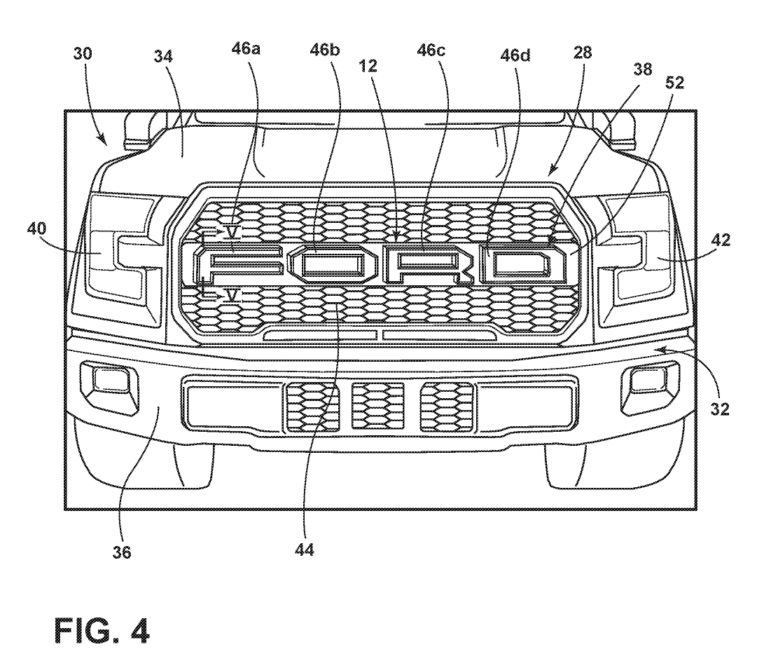

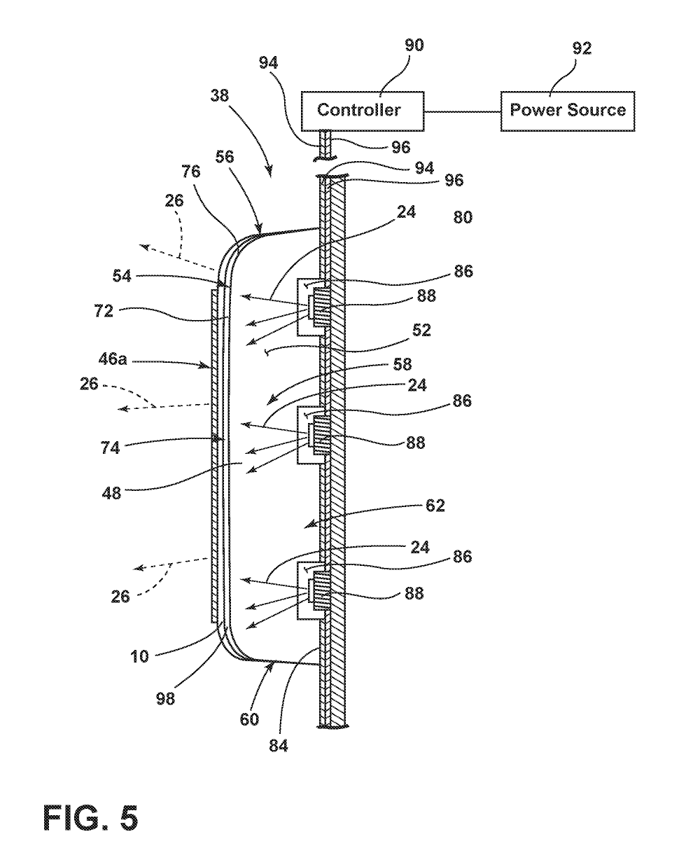

Referring to FIGS. 4 and 5, the indicia 46a, in some examples, may be opaque and light may be emitted around the indicia 46a-46d. The substrate 48 may define one or more cavities 86. In some examples, one or more light sources 88 are disposed within each respective cavity 86. The light sources 88 are operably coupled with a controller 90 and a power source 92, which includes a conventional vehicle power source or an independent power source. The controller 90 may include control circuitry that includes LED drive circuitry for controlling activation and deactivation of the light sources 88. In some instances, the substrate 48 is sealingly coupled to the panel 50 to at least partially protect any component (e.g., the light source 88) disposed therebetween. As used herein, “sealingly coupled” will be construed to mean any two components that are coupled to one another and contact (possibly directly to) one another.

The light sources 88 may include any form of light sources. For example, fluorescent lighting, light-emitting diodes (LEDs), organic LEDs (OLEDs), polymer LEDs (PLEDs), laser diodes, quantum dot LEDs (QD-LEDs), solid-state lighting, a hybrid of these or any other similar device, and/or any other form of lighting may be utilized within the lighting assembly 38. Further, various types of LEDs are suitable for use as the light sources 88 including, but not limited to, top-emitting LEDs, side-emitting LEDs, and others. Moreover, according to various examples, multicolored light sources 88, such as Red, Green, and Blue (RGB) LEDs that employ red, green, and blue LED packaging may be used to generate various desired colors of light outputs from a single light source 88, according to known light color mixing techniques. In operation, the controller 90 may selectively control the light sources 88 such that one, all, or a portion of the light sources 88 can be activated at any given time.

Each light source 88 is operably coupled with a pair of electrical leads 94, 96. The electrical leads 94, 96 may be formed from any conductive material and be disposed between the panel 50 and the substrate 48, within the substrate 48, and/or within the panel 50. In some examples, the leads 94, 96 may be formed from a material that is capable of supporting the light sources 88 thereon. In such instances, the light sources 88 may be welded, soldered, and/or otherwise attached to either of the leads 94, 96 for supporting the light sources 88.

In other examples, a circuit board may be disposed between the substrate 48 and the panel 50. In yet other examples, the circuit board may form a portion of the substrate 48 and/or the panel 50. The circuit board may be configured as a printed circuit board (PCB) that may be flexible or rigid. In some examples, conductive leads 94, 96 on the circuit board may also be flexible such that the leads 94, 96 may extend or contract without breaking as the circuit board is bent from a neutral position. The bending of the grille 28 may occur when the grille 28 is contacted by a person and/or an object. Additionally, bending of the grille 28 may occur due to temperature variations of the grille 28 in response to heat generated by the ambient environment in which the vehicle 30 is operated and/or heat generated by the vehicle 30.

The substrate 48 may be transparent and/or translucent and capable of accepting environmental excitation light 24 from the upper portion 56 and/or the lower portion 60 of the substrate 48 and/or the light sources 88. The substrate 48 may have a decorative layer 98 disposed thereon. In a deactivated state, the decorative layer 98 is configured to control or modify an appearance of the grille 28. Once the light source 88 is activated, excitation light 24 is transmitted through a portion of the substrate 48 in a predefined manner to increase the visibility of the indicia 46a. In some examples, the indicia 46a may be opaque regions that are disposed within the decorative layer 98, forwardly of the decorative layer 98, and/or rearward of the decorative layer 98.

In various examples, the decorative layer 98 may confer a plurality of various patterns, textures, colors, etc. to various portions of the substrate 48. The decorative layer 98 can be disposed on an interior and/or an exterior surface of the substrate 48 through any method known in the art, including, but not limited to, sputter deposition, vacuum deposition (vacuum evaporation coating), electroplating, and/or printing onto the substrate 48. The decorative layer 98 may be chosen from a wide range of materials and/or colors, including, but not limited to, silver, chrome, copper, bronze, gold, or any other colored surface. Additionally, an imitator of any metallic material may also be utilized without departing from the teachings provided herein. In various examples, the decorative layer 98 may have a textured or grained surface.

The luminescent structure 10 may be disposed between the indicia 46a and the decorative layer 98. Alternatively, and/or additionally, the luminescent structure 10 may be disposed between the substrate 48 and the decorative layer 98. As discussed above, the luminescent structure 10 may appear in a first color (e.g., white) in a non-luminescent state and emit converted light 26 of a second color (e.g., blue) in a luminescent state. In some examples, the light source 88 may emit a blueish white light that charges the luminescent structure 10 when the light source 88 is activated. The light source 88 may emit more excitation light 24 than the luminescent structure 10 can convert, thus the light emitted from the grille 28 may be a combination of excitation light 24 and converted light 26. The combined light, in some examples, may be a neutral white light as the luminescent structure 10 may convert some of the blue light emitted from the light source 88. Alternatively, the luminescent structure 10 may be concealed and/or not readily visible in a non-luminescent state and emit converted light 26 of any color in a luminescent state. The luminescent structure 10 may include a long-persistence luminescent material, as described above, such that the luminescent structure 10 may luminesce for extended durations, such as a period of several minutes or hours, once a night-like lighting condition occurs.

Referring still to FIG. 5, when the light sources 88 are deactivated, the substrate 48 may confer a desired appearance that is defined by the decorative layer 98, a color of a precursor material forming the substrate 48 and/or the panel 50, a color of the indicia 46a, and/or a color of the luminescent structure 10 (in a non-luminescent and/or a luminescent state). In some examples, the indicia 46a may be backlit in a first color (e.g., white) when an additional lamp of the vehicle 30, such as a headlamp 40, 42 (FIG. 1), is activated. When the headlamp 40, 42 is deactivated, the light source 88 may be also be deactivated while the luminescent structure 10, charged by the light source 88 and/or environmental excitation light 24, will continue to emit converted light 26. The converted light 26 may be of a second color (e.g., blue) that backlights the indicia 46a. The backlighting may be visible during night-like and/or day-like conditions.

While the headlamp 40, 42 and the light sources 88 are deactivated, the luminescent structure 10 emits light in a plurality of directions. In order to direct light in a desired direction, the decorative layer 98, which may be disposed vehicle rearward of the luminescent structure 10, may redirect the converted light 26 in a forward direction, or in any other desired direction thereby forming the reflector 72. In some examples, the decorative layer 98 and/or the luminescent structure 10 may extend along a forward surface and a top or bottom surface of the substrate 48 such that a first portion is offset from a second portion.

Referring to FIG. 6, the light sources 88 of the grille 28 are operably connected to the controller 90 that may correspond to a standalone controller or be otherwise integrated with an existing vehicle system. The controller 90 includes a memory 100 having instructions 102 stored thereon that are executable by a processor 104. The instructions 102 may generally relate to ways in which to operate the light sources 88 to affect the manner in which the grille 28 illuminates or luminesces. The controller 90 may also communicate with other vehicle devices such as, but not limited to, an ambient light sensor 106, a speed sensor 108, a vehicle lighting control system 110, as well as a body control module 112 of the vehicle 30. By leveraging these vehicle devices, the grille 28 may provide a variety of functional and/or aesthetic lighting. For example, the grille 28 may illuminate as a supplemental daytime running lamp, a hazard light, or a turn indicator. The grille 28 may also be illuminated during a welcome or departure event when a user unlocks or locks the vehicle 30. While a few specific examples have been provided herein, it will be apparent to those of ordinary skill in the art that the grille 28 may be illuminated to provide other types of lighting without departing from the scope of the present disclosure.

A variety of advantages may be derived from the use of the present disclosure. For example, use of the disclosed grille provides a unique aesthetic appearance to the vehicle. Moreover, the grille may provide lighting forwardly and/or outward of the vehicle. In some examples, the grille includes a luminescent structure that may provide passive illumination to the vehicle. The active and/or passive illumination of the grille may illuminate and/or backlight indicia on the vehicle. Various designs may be obtained through a single grille based on the source of excitation light and/or the visibility of the converted light. The grille may be manufactured at low costs when compared to standard vehicle lighting assemblies.

According to various examples, a vehicle lighting assembly is provided herein. The vehicle lighting assembly includes a substrate configured to direct excitation light therethrough. A reflector is disposed along a portion of the substrate, the reflector having an offset orientation. A luminescent structure is disposed on an opposing side of the reflector from the substrate. Examples of the vehicle lighting assembly can include any one or a combination of the following features:
an elongated panel disposed on an opposing side of the substrate from the reflector;
a decorative layer disposed on the panel;
the substrate extends forwardly of the panel to define one or more indicia;
a protective layer disposed on an opposing side of the luminescent structure from the reflector;
an upper portion of the substrate has a front portion and a rear portion, the rear portion disposed vertically above the front portion to assist in increasing the amount of excitation light that is directed into the substrate;
a lower portion of the substrate has a front portion and a rear portion, the rear portion disposed vertically below the front portion;
a light source disposed proximate an opposing side portion of the substrate from the reflector;
the substrate defines a cavity and the light source is disposed within the cavity;
the reflector is translucent thereby allowing light to pass therethrough;
the luminescent structure is a first color in a non-luminescent state and emits converted light of a second color in a luminescent state; and/or
the lighting assembly is disposed within a vehicle grille.

Moreover, a method of manufacturing a vehicle lighting assembly is provided herein. The method includes forming a substrate configured to direct excitation light therethrough. The method also includes positioning a reflector disposed along a portion of the substrate, the reflector having an offset orientation. Lastly, the method includes disposing a luminescent structure on an opposing side of the reflector from the substrate.

According to some examples, a vehicle lighting assembly is provided herein. The vehicle lighting assembly includes a substrate configured to direct excitation light therethrough. A reflector is disposed along a portion of the substrate, the substrate extending upwardly of the substrate. A luminescent structure is disposed on an opposing side of the reflector from the substrate. A panel is disposed on an opposing side of the substrate from the reflector. Examples of the vehicle lighting assembly can include any one or a combination of the following features:
a decorative layer disposed on the panel;
an upper portion of the substrate has a front portion and a rear portion, the rear portion disposed vertically above the front portion to assist in increasing the amount of excitation light that is directed into the substrate; and/or
a protective layer disposed on an opposing side of the luminescent structure from the reflector.

According to other examples, a vehicle lighting assembly is provided herein. The vehicle lighting assembly includes a light source disposed between a substrate and a panel. A decorative layer is disposed on an opposing side of the substrate from the light source. A luminescent structure disposed on an opposing side of the decorative layer from the substrate. An indicia is disposed on the luminescent structure. Examples of the vehicle lighting assembly can include any one or a combination of the following features:
the luminescent structure is a first color in a non-luminescent state and emits converted light of a second color in a luminescent state;
the indicia may be backlit in a first color when an additional light source of a vehicle is activated; and/or
the luminescent structure continues to emit converted light of a second color that backlights the indicia when the additional light source of the vehicle is deactivated.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

Implementations of the systems, apparatuses, devices, and methods disclosed herein may include or utilize a special-purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general-purpose or special-purpose computer system. Computer-readable media that store computer-executable instructions are computer storage media (devices). Computer-readable media that carry computer-executable instructions are transmission media. Thus, by way of example, and not limitation, implementations of the present disclosure can include at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general-purpose or special-purpose computer. Combinations of the above should also be included within the scope of computer-readable media.

Computer-executable instructions include, for example, instructions and data, which, when executed at a processor, cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through the network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor examples discussed above might include computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Examples of the present disclosure may be implemented in further types of devices, as would be known to persons skilled in the relevant art(s).

At least some examples of the present disclosure have been directed to computer program products including such logic (e.g., in the form of software) stored on any computer usable medium. Such software, when executed in one or more data processing devices, causes a device to operate as described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system might be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A vehicle lighting assembly comprising:
a substrate configured to direct excitation light therethrough;
a reflector disposed along a portion of the substrate, the reflector having an offset orientation; and
a luminescent structure disposed on an opposing side of the reflector from the substrate.

2. The vehicle lighting assembly of claim 1, further comprising:
an elongated panel disposed on an opposing side of the substrate from the reflector.

3. The vehicle lighting assembly of claim 2, further comprising:
a decorative layer disposed on the panel.

4. The vehicle lighting assembly of claim 2, wherein the substrate extends forwardly of the panel to define one or more indicia.

5. The vehicle lighting assembly of claim 1, further comprising:
a protective layer disposed on an opposing side of the luminescent structure from the reflector.

6. The vehicle lighting assembly of claim 1, wherein an upper portion of the substrate has a front portion and a rear portion, the rear portion disposed vertically above the front portion to assist in increasing the amount of excitation light that is directed into the substrate.

7. The vehicle lighting assembly of claim 1, wherein a lower portion of the substrate has a front portion and a rear portion, the rear portion disposed vertically below the front portion.

8. The vehicle lighting assembly of claim 1, further comprising:
a light source disposed proximate an opposing side portion of the substrate from the reflector.

9. The vehicle lighting assembly of claim 8, wherein the substrate defines a cavity and the light source is disposed within the cavity.

10. The vehicle lighting assembly of claim 1, wherein the reflector is translucent thereby allowing light to pass therethrough.

11. The vehicle lighting assembly of claim 1, wherein the luminescent structure is a first color in a non-luminescent state and emits converted light of a second color in a luminescent state.

12. The vehicle lighting assembly of claim 1, wherein the lighting assembly is disposed within a vehicle grille.

13. A vehicle lighting assembly comprising:
a substrate configured to direct excitation light therethrough;
a reflector disposed along a portion of the substrate, the substrate extending upwardly of the substrate;
a luminescent structure disposed on an opposing side of the reflector from the substrate; and
a panel disposed on an opposing side of the substrate from the reflector.

14. The vehicle lighting assembly of claim 13, further comprising:
a decorative layer disposed on the panel.

15. The vehicle lighting assembly of claim 13, wherein an upper portion of the substrate has a front portion and a rear portion, the rear portion disposed vertically above the front portion to assist in increasing the amount of excitation light that is directed into the substrate.

16. The vehicle lighting assembly of claim 13, further comprising:
a protective layer disposed on an opposing side of the luminescent structure from the reflector.

17. A vehicle lighting assembly comprising:
a light source disposed between a substrate and a panel;
a decorative layer disposed on an opposing side of the substrate from the light source;
a luminescent structure disposed on an opposing side of the decorative layer from the substrate; and
an indicia disposed on the luminescent structure.

18. The vehicle lighting assembly of claim 17, wherein the luminescent structure is a first color in a non-luminescent state and emits converted light of a second color in a luminescent state.

19. The vehicle lighting assembly of claim 17, wherein the indicia may be backlit in a first color when an additional light source of a vehicle is activated.

20. The vehicle lighting assembly of claim 19, wherein the luminescent structure continues to emit converted light of a second color that backlights the indicia when the additional light source of the vehicle is deactivated.
